(19) United States
(12) Patent Application Publication
(10) Pub. No.: US 2024/0295631 A1
(43) Pub. Date: Sep. 5, 2024

(54) MULTI-MISSION RADAR SYSTEM

(71) Applicant: General Radar Corporation, Belmont, CA (US)

(72) Inventors: Dmitry Turbiner, Mountain View, CA (US); Jon Williams, Mountain View, CA (US)

(21) Appl. No.: 18/594,946

(22) Filed: Mar. 4, 2024

Related U.S. Application Data
(60) Provisional application No. 63/488,059, filed on Mar. 2, 2023.

(51) Int. Cl. G01S 7/41; G01S 7/02; G01S 7/03; G01S 7/40; G01S 13/91; G01S 13/95

(52) U.S. Cl. CPC G01S 7/417; G01S 7/023; G01S 7/032; G01S 7/4021; G01S 13/91; G01S 13/951; G01S 2013/916

(57) ABSTRACT

Methods, systems, and apparatus, including computer programs encoded on computer storage media, for a multi-purpose radar. The multi-purpose radar system includes one or more subarrays of electronically steered transmit/receive elements, a digital signal processing subsystem that includes a plurality of digital processing elements and a memory subsystem that includes one or more memories, an analog-to-digital subsystem configured to receive the analog output of the one or more subarrays and to store a digital representation of the analog output into the memory subsystem, and a control subsystem configured to direct the digital signal processing subsystem to perform a plurality of different processing algorithms on the data stored in the memory subsystem.

### CROSS-REFERENCE TO RELATED APPLICATIONS

This application claims benefit of U.S. Provisional Application No. 63/488,059, filed on Mar. 2, 2023, the entirety of which is herein incorporated by reference.

### BACKGROUND

This specification relates to radar systems.

Radar systems typically operate by transmitting a signal from a transmitter and searching for reflections of the signal off one or more target entities in an operating environment. In order to maximize performance, radar systems are typically highly tailored to the target entity being detected in terms of the hardware used as well as the properties of the signal that is transmitted and the processing algorithms used to process radar returns. Therefore, a weather radar usually has much different hardware, and uses much different signal patterns, than an air traffic control radar. A missile defense radar will also typically have different hardware, antenna patterns, and signal processing hardware than a weather radar.

Thus, there are many reasons that a radar designed for one mission or type of application cannot be used for a different mission or application type. This can be because the hardware signal generators do not generate the right signals or the hardware components are unable to store enough data or process data fast enough.

### SUMMARY

This specification describes a multi-purpose radar system that can simultaneously perform multiple applications. In particular, the systems described in this specification can perform simultaneous, on-demand, multi-domain radar applications due to a combination of capabilities, including the ability to perform on-demand resource provisioning, the ability to generate arbitrary waveforms, the processing power to perform arbitrary signal processing algorithms on full range windows at full bandwidth, and a modular design that allows scaling up the power of the transmitted signals and the sensitivity of the receivers as appropriate.

Particular embodiments of the subject matter described in this specification can be implemented so as to realize one or more of the following advantages.

A multi-purpose radar system uses reconfigurable modular hardware to perform applications for various radar purposes simultaneously, as some applications require significantly more processing demands (e.g., higher range resolution and lower detectability thresholds) than other applications. The multi-purpose radar leverages a general-purpose computing software architecture with highly reconfigurable radar hardware to support full-range processing and high-bandwidth processing simultaneously without compromising data fidelity in range or in bandwidth. The hardware reconfigurability of the radiating elements of the multi-purpose radar system enable the multi-purpose radar system to be versatile, by various polarization configurations that can be tailored to particular applications. The reconfigurability of the hardware also enables the multi-purpose radar system to capture various transmit/receive module power amplifier configurations that can be provided or tailored based on cost and performance needs.

The hardware modularity of the multi-purpose radar system provides customization at every step of the signal processing pipeline between the algorithms that process radio frequency signals to the transmit and receive modules at the antenna of the multi-purpose radar system. In comparison to some radar systems that are tailored to a specific application, the multi-purpose radar system provides reconfigurability to enable radar technology previously considered to be impractical or expensive.

A multi-purpose radar system with scalable subarrays allows the multi-purpose radar system to be portable, tailored, and reconfigurable depending on the application needs of the multi-purpose radar system. The scalable subarrays provide that radar hardware can be configured at production (in a factory, during radar system assembly, etc.) for various mission or applications needs and purposes. The scalable subarrays expand opportunities to readily deploy the multi-purpose radar systems and provide general purpose computing to multiple radar applications at the same time, as well as simultaneously processing of the same radar data to fulfill different purposes. For example, the multi-purpose radar system can be deployed as a gap-filler radar to provide additional coverage to radar system systems with inadequate coverage, e.g., radar blind spots, areas limited in range, altitude, or elevation.

A scalable subarray in the multi-purpose radar system enables high-performance radar to be utilized for a wide variety of applications, compared to using a number of radars that are each tailored to a specific application. The scalability of the hardware such as the subarray enables the multi-purpose radar system to be reconfigurable based on application type needs. Furthermore, the scalable design of the multi-purpose radar system provides a lower financial cost (e.g., compared to oversized and highly specialized radar systems) such that multiple multi-purpose radar systems can be operated as an easily integrated network (e.g., multiple multi-purpose systems integrated with one another) to achieve a wide coverage in circumstances where additional coverage is beneficial but too complex or expensive to achieve. The software architecture of the multi-purpose radar system provides a consolidated interface to achieve wider coverage without integrating different hardware and software across radar systems, e.g., any multi-purpose radar system can operate a radar network of multi-purpose radar systems.

The radar network of multi-purpose radar systems can provide numerous benefits in wireless communication with satellites and other command systems. The multi-purpose radar system itself provides low latency communication in network communication that can be further improved by using a network of multi-purpose radar systems.

A multi-purpose radar system also provides improved computational efficiency by simultaneously performing different types of radar applications and dynamically responding to environmental conditions. The multi-purpose radar system can perform applications such as missile defense, weather monitoring, wind turbine interference mitigation, interceptor support, electromagnetic interference mitigation, aircraft detection and tracking, and so on. The simultaneous processing (e.g., by general purpose computing architecture) provided by the multi-purpose radar system can enable these different types of applications (e.g., by accounting for processing loads and algorithm complexity of the different types of applications) to be efficiently prioritized and performed, leveraging general purpose computing to perform signal processing. The multi-purpose radar system can achieve improved search, tracking, identification, and scheduling performance with modularity and reconfigurability at every level of hardware and software (e.g., from backend to frontend).

The multi-purpose radar system provides simultaneous processing regardless of the application and can adjust processing priority based on a variety of factors such as external prioritization from a remote device (e.g., a command and control center) and monitored environmental factors. The multi-purpose radar system can capture range windows at full-range and full-bandwidth and perform a variety of algorithm processes to achieve results for different types of applications. The simultaneous processing performed by the multi-purpose radar system can apply additional signal processing techniques using general-purpose supercomputing software architecture and achieve higher resolution radar data even using existing waveforms. Furthermore, the modularity and reconfigurability of elements in the subarrays enable additional capabilities to be provided such as digital beamforming to achieve improvements in object tracking and identification.

In an aspect, a multi-purpose radar system includes one or more subarrays of electronically steered transmit/receive elements, a digital signal processing subsystem including a plurality of digital processing elements and a memory subsystem including one or more memories, an analog-to-digital subsystem configured to receive the analog output of the one or more subarrays and to store a digital representation of the analog output into the memory subsystem, and a control subsystem configured to direct the digital signal processing subsystem to perform a plurality of different processing algorithms on the data stored in the memory subsystem.

The multi-purpose radar system is configured to simultaneously perform multiple different applications having different respective processing algorithms, each of the multiple different applications correspond to a different type of application. In some implementations, simultaneously performing multiple different applications can include directing the digital signal processing subsystem to perform multiple different processing algorithms on the same set of data stored in the memory subsystem. Simultaneously performing multiple different applications can include directing the digital signal processing subsystem to perform multiple different processing algorithms over consecutive operational cycles of the radar. In some implementations, simultaneously performing multiple different applications includes cycling between two or more processing algorithms over consecutive operational cycles of the radar.

The control subsystem can be configured to dynamically select a next processing algorithm for a next application on each operational cycle. In some implementations, the control subsystem is configured to select a next processing algorithm while digital signal processing subsystem is processing data for a current processing algorithm. The control system can be configured to perform a real-time resource allocation process to determine which resources to allocate to each of the multiple different application types. In some implementations, performing the resource allocation process includes determining an amount of processing time to allocate to each of the multiple different application types. In some implementations, performing the resource allocation process includes allocating no processing resources to one of the application types. In some implementations, performing the resource allocation process includes reducing processing resources for one of the applications over one or more operational cycles.

The plurality of digital processing elements of the digital signal processing subsystem can be graphics processing units and the memory subsystem is one or more integrated memories of the graphics processing units. In some implementations, the memory subsystem is configured to store an entire range window of data over a wide portion of RF spectrum. The range window stored by the memory subsystem can be over 100 km of range and can be processed at full bandwidth of the multi-purpose radar system.

In some implementations, the multi-purpose radar system includes a digital-to-analog subsystem that is configured to generate arbitrary waveforms. The digital-to-analog subsystem can be a modular subsystem that can be replaced by an alternative digital-to-analog subsystem.

In some implementations, the one or more subarrays of electronically steered transmit/receive elements are configured to capture a wide portion of the RF spectrum.

In some implementations, the control subsystem is configured to determine a malfunction of the multi-purpose radar system, and in response to determining the malfunction, reconfigure antenna weights. The control subsystem can be configured to select a different processing algorithm for a particular application type. In some implementations, the control subsystem is configured to detect electromagnetic interference in a receive signal of the analog-to-digital subsystem, and in response to detecting electromagnetic interference, select a different waveform for transmit by the one or more subarrays. The control subsystem can be configured to detect electromagnetic interference in a receive signal of the analog-to-digital subsystem and in response to detecting electromagnetic interference, select a different resource allocation for a subsystem of the multi-purpose radar system. In some implementations, selecting a different processing algorithm includes switching from a searching or tracking algorithm to an algorithm for communicating data wirelessly. In some implementations, the control subsystem is configured to integrate results of one or more processing algorithms with processing results received from one or more other multi-purpose radar systems to ensure time and phase alignment coherency.

In some implementations, the multi-purpose radar system is configured to simultaneously perform two or more of the following applications: aircraft detection, aircraft tracking, communications, weather monitoring, or interceptor guidance. The multi-purpose radar system can be configured to perform at least one type of application simultaneously.

In an aspect, a method performed by a radar system in an environment include obtaining, by an antenna array of the radar system, radio frequency detections from one or more objects in the environment. The method includes identifying, by a digital signal processing subsystem of the radar system, a first subset of the radio frequency detections for processing during a first period of time. The method includes processing, during the first period of time and by the digital signal processing subsystem of the radar system, the first subset of radio frequency detections to identify objects from the one or more objects in the environment associated with a first application of the radar system, and while processing the first subset of radio frequency detections for the first application of the radar system during the first period of time, identifying a second subset of the radio frequency detections for processing during a second period of time. The second subset of radio frequency detections are associated with a second application of the radar system. The method includes processing, during the second period of time and by the digital signal processing subsystem of the radar system, the second subset of radio frequency detections to identify objects from the one or more objects in the environment associated with the second application of the radar system, and generating radar data related to one or more identified objects from the one or more objects based on processing the first subset of radio frequency detections and the second subset of radio frequency detections.

In some implementations, the method includes determining, from an ordered list of applications, a sequence of waveforms corresponding to a plurality of beams. The ordered list of applications can include at least one of (i) different instances of an identical application, or (ii) an instance of different applications. The method includes generating, from the sequence of waveforms, the plurality of beams for transmit by the antenna array of the radar system. The method includes obtaining, through the antenna array of the radar system, received signals associated with the transmitted plurality of beams, and processing, for each beam of the transmitted plurality of beams and according to the ordered list of applications, a subset of the received signals associated with the beam.

In some implementations, the method includes identifying a subset of beams from the transmitted plurality of beams that share an identical application type, and providing detections associated with the subset of the received signals that share the identical application type.

In some implementations, the ordered list of radar applications is based on data received from one or more interfaces of the radar system. In some implementations, generating the plurality of beams for transmit includes steering the beams at one or more positions of an environment of the radar system based on the sequence of waveforms.

In an aspect, one or more computer storage media encoded with instructions that are operable, when executed by data processing apparatus, to cause the data processing apparatus to perform operations. The operations include obtaining, by an antenna array of the radar system, radio frequency detections from one or more objects in the environment. The operations include identifying, by a digital signal processing subsystem of the radar system, a first subset of the radio frequency detections for processing during a first period of time. The operations include processing, during the first period of time and by the digital signal processing subsystem of the radar system, the first subset of radio frequency detections to identify objects from the one or more objects in the environment associated with a first application of the radar system, and while processing the first subset of radio frequency detections for the first application of the radar system during the first period of time, identifying a second subset of the radio frequency detections for processing during a second period of time. The operations include processing, during the second period of time and by the digital signal processing subsystem of the radar system, the second subset of radio frequency detections to identify objects from the one or more objects in the environment associated with a second application of the radar system, the second application different from the first application. The operations include generating radar data related to one or more identified objects from the one or more objects based on processing the first subset of radio frequency detections and the second subset of radio frequency detections.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A illustrates an example multi-purpose radar system performing multiple tasks simultaneously.

FIG. 1B illustrates an example interface diagram of a multi-purpose radar system.

FIG. 2A illustrates an example block diagram of a multi-purpose radar system.

FIG. 2B illustrates an example block diagram for an array of a multi-purpose radar system.

FIG. 2C illustrates an example of a distributed network of multi-purpose radar systems.

FIG. 3A illustrates an example of an active electronically scanned array (AESA) antenna of a multi-purpose radar system.

FIG. 3B illustrates another example subarray configuration of a multi-purpose radar system.

FIG. 4 illustrates an example modular antenna array of radiating elements from a subarray of a multi-purpose radar system.

FIG. 5 illustrates an example process performed by a multi-purpose radar system.

Like reference numbers and designations in the various drawings indicate like elements.

### DETAILED DESCRIPTION

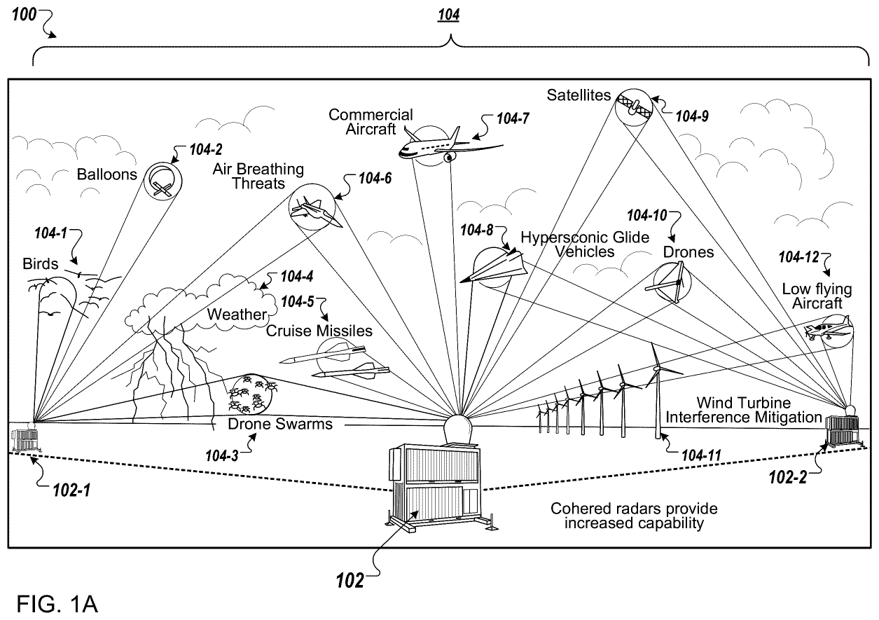

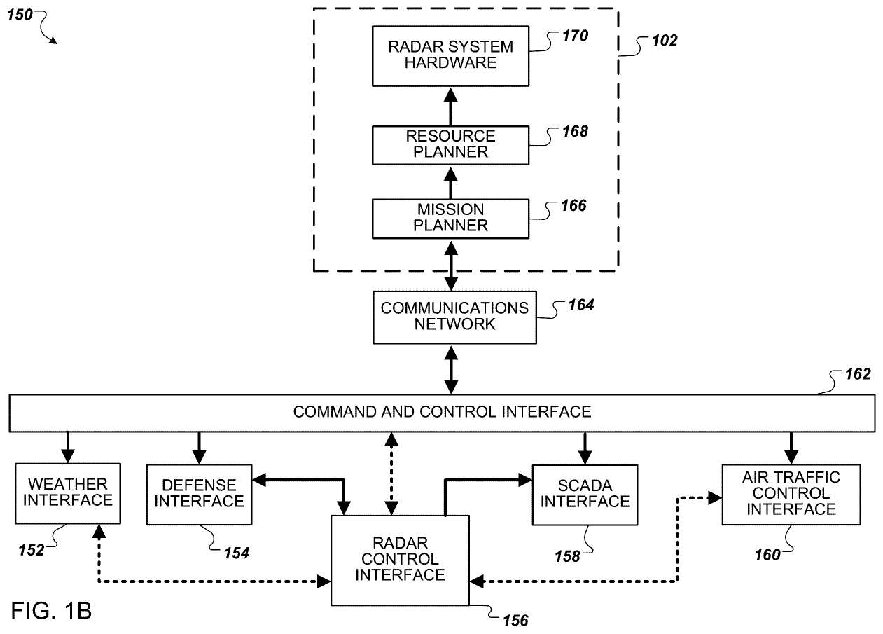

FIG. 1A illustrates an example multi-purpose radar system 102 in an environment 100, performing numerous applications simultaneously. The system 102 is an example of a system that can perform simultaneous, on-demand, multi-domain radar applications. In some cases, multiple multi-purpose radar systems, such as multi-purpose radar system 102, 102-1, and 102-2 depicted in FIG. 1A, can be configured to operate together to perform multiple radar applications simultaneously.

A radar application being on-demand means that the system can provision resources for performing the radar application at any selected point in time and can likewise de-provision resources at any selected point in time to perform a different application. This is very unlike traditional radar systems that are designed and manufactured from the ground up to always perform the same application or series of applications. Thus, the system 102 can not only switch to other applications in real-time, the on-demand capabilities of the system 102 allow it to switch to different combinations of simultaneous applications at any selected point in time.

A set of multi-domain radar applications means that the applications are from different classes of radar problems. For example, aircraft tracking radars and weather tracking radars perform applications in different domains. Weather tracking radars and radars used for data communications perform applications in different domains. Some conventional radars that perform multiple applications cannot perform multi-domain applications because they lack the capabilities described in this specification, including lacking the ability to generate arbitrary waveforms.

The multi-purpose radar system 102 can perform defense applications such as object detection (e.g., tracking targets for missile defense) and commercial applications such as aircraft detection/tracking, and weather monitoring (e.g., identifying changes in weather patterns). As illustrated in FIG. 1A, the multi-purpose radar system 102 can detect and track objects 104-1 through 104-12 (collectively referred to as “objects 104”). Although FIG. 1A depicts the multi-purpose radar system 102 detecting and tracking a particular number and type of object, the number and types of objects may be based on the processing capacity and capability of components of multi-purpose radar system 102 (e.g., radar hardware and software).

As an example, the multi-purpose radar system 102 can identify various types of threats such as cruise missiles (e.g., cruise missiles 104-5), hypersonic glide vehicles (e.g., hypersonic glide vehicles 104-8), balloons (e.g., balloons 104-5), satellites (e.g., balloons 104-9), unidentified flying objects, and drones (e.g., drones 104-10). Other examples of detected objects depicted in FIG. 1A include birds 104-1, drone swarms 104-3, weather patterns 104-4, commercial aircraft 104-7, wind turbines 104-11, and low flying aircraft 104-12. Results obtained by the multi-purpose radar system 102 (e.g., by processing detections of the identified threats) can be provided to a battle manager system, e.g., a launcher system with interceptors to shoot down the identified targets. Simultaneously, the multi-purpose radar system 102 can perform commercial applications to provide weather data and other types of applications (e.g., satellite communications) to fulfill multiple purposes using radar data of an environment 100.

As an example, the simultaneous operation achieved by the multi-purpose radar system 102 can include switching between different types (e.g., commercial, defense, communications) of applications. Simultaneous operation of the multi-purpose radar system 102 can include processing the same full-range radar data with full-bandwidth acquired during an operational cycle (or some number of operational cycles) and performing various types of algorithm processing (e.g., each type of algorithm corresponding to a respective application type) to generate multiple sets of radar results based on the different types. In some implementations, the scan pattern of the multi-purpose radar system 102 can be adjusted to achieve a different type of application than the current application type being performed.

The multi-purpose radar system 102 can also provide support to interceptors (e.g., a defense application to enable interceptors to destroy targets) while performing another type of application (e.g., commercial application) simultaneously, or instead of the other performed applications. By providing data related to the interceptor and potential targets, multi-purpose radar system 102 can reduce errors between estimated and actual position and improve the probability of successful intercept. For example, the multi-purpose radar system 102 can receive instructions from a command and control center to adjust operation of the subsystems and subarrays (e.g., adapting from any application being performed to a different application) and provide interceptor support data (e.g., target data, interceptor data, communication link data) to the interceptor.

As another example, the multi-purpose radar system 102 can detect various types of aircraft and provide air traffic control (e.g., adjusting flight patterns and monitoring airspace for detected aircraft) while simultaneously performing other commercial applications such as weather monitoring and defense applications such as missile defense. By providing (e.g., to air traffic control towers, aircraft, and other systems associated with air traffic control) data related to the detected aircraft, the multi-purpose radar system 102 can reduce risks of collisions and improve the flow of air traffic, while providing data to support defense applications and other commercial applications. The multi-purpose radar system 102 can reduce congestion in different sections of airspace and improve air travel (e.g., reduced risk of flight delays, improved efficiency of airspace).

The multi-purpose radar system 102 can perform commercial applications such as in weather monitoring to determine a type, severity, and duration of precipitation. As an example, the multi-purpose radar system 102 can perform weather monitoring simultaneously with defense applications such as object detection and tracking. By performing weather monitoring in addition to object tracking applications (e.g., defense applications), the multi-purpose radar system 102 can provide highly accurate data for tracked objects, despite conditions that obscure radar performance (e.g., rain, snow). The multi-purpose radar system 102 can also perform commercial applications coupled to other systems and devices such as wind turbines (e.g., in a wind farm) while performing defense applications. As an example, the multi-purpose radar system 102 can provide data to systems (e.g., other radar systems, command and control centers) to mitigate interference generated by wind turbines, thereby improving performance for both commercial and defense applications.

Simultaneous performance of applications can include the multi-purpose radar system 102 performing multiple different types (e.g., commercial, defense, communications, distributed) of applications that each use different algorithms, at the same time. These different types of applications can include commercial applications such as weather monitoring and air traffic control while defense applications can include missile defense and interceptor support. The multi-purpose radar system 102 can also simultaneously perform different algorithms on the same set of data (e.g., received detections), as well as performing different algorithms corresponding to different application types over consecutive operational cycles of the radar. In some implementations, the multi-purpose radar system 102 can cycle between two or more algorithms with different corresponding applications, e.g., switching between algorithms that correspond to commercial applications and algorithms that correspond to defense applications, over consecutive operational cycles of the radar to provide simultaneous performance. The multi-purpose radar system 102 can pre-emptively select algorithms for any number of operational cycles in preparation for one or more applications to be performed. Furthermore, the multi-purpose radar system 102 can also select algorithms corresponding to a different application type (e.g., defense) in preparation for one or more applications of the different type (e.g., defense) to be performed while processing data for a current algorithm with a current application type (e.g., commercial) being performed.

In addition to simultaneously performing applications, the multi-purpose radar system 102 includes multiple simultaneous interfaces (e.g., providing an interface for a respective application). FIG. 1B depicts an example interface diagram 150 for a multi-purpose radar system, e.g., multi-purpose radar system 102, and can include interfaces to other systems for different types of applications. The diagram 150 depicts communications across different interfaces for different types of applications, and communications between a high-level interface (e.g., command and control interface 162) for the multi-purpose radar system 102.

For example, FIG. 1B illustrates a first interface for weather prediction depicted as weather interface 152 (e.g., an interface corresponding to a first application type), that can be provided in addition to a second interface for missile defense depicted as defense interface 154 (e.g., corresponding to a second application type). The multiple interfaces can be provided and updated while the multi-purpose radar system 102 performs the multiple applications (e.g., including different application types) simultaneously. The multiple interfaces corresponding to multiple applications can be configured to provide output data (e.g., including subsets of output data) associated with each application to the command and control interface 162. The command and control interface 162 can obtain data collected by a particular system by a respective interface of the system, e.g., data for defense applications from the defense interface 154.

FIG. 1B also illustrates a radar control interface 156 for operation of the multi-purpose radar system 102. The radar control interface 156 for the multi-purpose radar system 102 can be coupled to a Supervisory Control And Data Acquisition (SCADA) interface 158 configured to control one or more external subsystems. As another example, the radar control interface 156 can be coupled to air traffic control interface 160, e.g., an interface for an air traffic control system. In some implementations, the radar control interface 156 can simultaneously access data from and provide data to multiple interfaces of different systems (e.g., weather interface 152, defense interface 154, SCADA interface 158, and air traffic control interface 160). The radar control interface 156 of the multi-purpose radar system 102 can include reconfigurable software applications to filter output data based on application type (e.g., commercial, communications, defense), as well as application priority, e.g., providing the interface corresponding to an application with the highest priority among multiple applications being performed, from the multiple interfaces. In some implementations, data from an interface of the multiple interfaces can be provided by wireless communication (e.g., to a remote battle manager, a weather prediction center, and so on). For example, FIG. 1B depicts a communications network 164 that couples the command and the control interface 162. In some implementations, the multiple interfaces (including data from an interface among the multiple interfaces) can be provided by a display of the multi-purpose radar system 102, e.g., on a monitor of the multi-purpose radar system 102 configured to display data, interfaces, and other types of information for different application types.

In some implementations, the communication network 164 can provide tasking, including messages, from the command and control interface 162 to the mission planner 166 of the multi-purpose radar system 102. The communications network 164 can be configured to send, receive, and process messages related to missions for the mission planner 166, which can be performed by the radar system hardware 170 (e.g., antenna elements, analog-to-digital converters, digital-to-analog converters) of the multi-purpose radar system 102. The mission planner 166 can be configured to request resources for the multi-purpose radar system 102. Some application types can demand intensive utilization of radar hardware and software resources to detect objects, e.g., detecting and tracking small, fast-moving objects such as drones can demand more resources than detecting and tracking large, slow-moving objects such as commercial aircraft. The mission planner 166 couples to a resource planner 168, which can be configured to prioritize resources (e.g., based on the application type) for the radar system hardware 170 of the multi-purpose radar system 102. In some implementations, the resource planner 168 is configured to plan a timeline of waveforms, e.g., scheduling waveforms to be transmitted by the multi-purpose radar system. In some implementations, the resource planner 168 can schedule waveforms based on a respective pulse-repetition frequency (PRF) of the waveform. Some waveforms for applications with relatively high resource demands can have higher PRFs compared to waveforms for applications with lower resource demands.

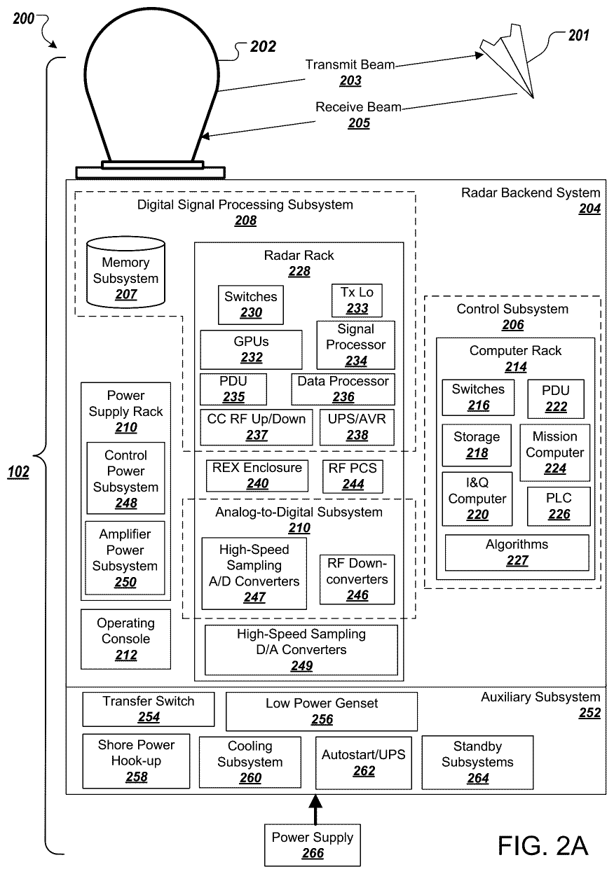

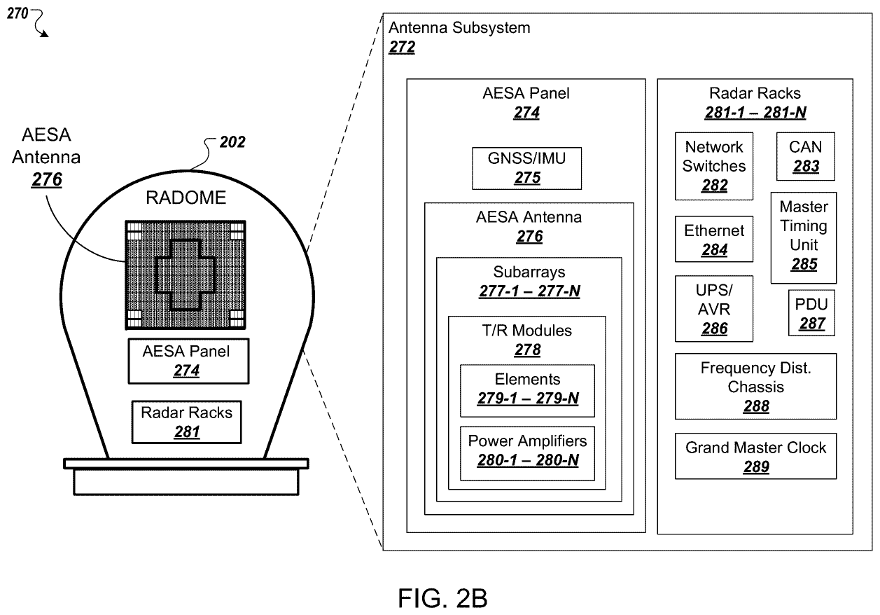

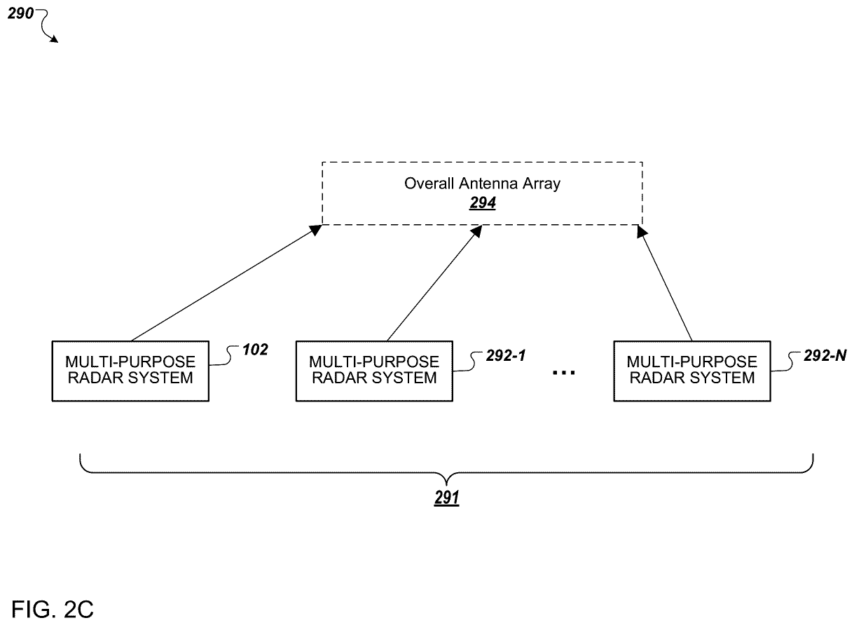

The multi-purpose radar system 102 includes subarrays of electronically steered transmit/receive elements (e.g., described in reference to FIGS. 2B, 3A, 3B, and 4 below, a digital signal processing subsystem, an analog-to-digital subsystem, and a control subsystem. The multi-purpose radar system 102 is configured to adjust operation of the subarrays or any of the subsystems based on the application being performed. Each application performed by the multi-purpose radar system 102 includes respective algorithms that process radar detections provided by the subarray. Associated parameters for an algorithm for a respective application of the multi-purpose radar system 102 can be adjusted based on the conditions of the environment 100. For example, the multi-purpose radar system 102 monitors one or more conditions of the environment 100 and can adjust operation of the subarrays and/or the subsystems (e.g., including algorithm parameters) in response to a detected condition (e.g., a change in weather patterns, an unidentified object). For example, the subsystems of the multi-purpose radar system 102 can determine how to adjust parameters without conflicting operation of the multiple types of applications being performed.

A defense application of the multi-purpose radar system 102 can include using subsystems to transmit radar waveforms and process received radar returns from detected objects in the environment 100. Radar functions performed by multi-purpose radar system 102 include searching for objects in the environment 100, tracking the detected objects, and identifying features of the detected objects such as object classification and type. Searching and tracking objects also include determining characteristics such as radar cross section (RCS), and signal-to-noise ratio (SNR). The multi-purpose radar system 102 can also perform electromagnetic mitigation (e.g., to mitigate the effects of electronic jamming techniques) and responsive resource scheduling, e.g., to improve resource utilization when scheduling waveforms. The subsystems support the multi-purpose radar system 102 to perform these defense applications with other types of applications (e.g., commercial, communications) simultaneously. The subsystems enable the multi-purpose radar 102 to allocate radar resources in real-time, improve radar performance, and adapt the multi-purpose radar system 102 in response to conditions presented in any environment, e.g., environment 100 across multiple application types being performed.

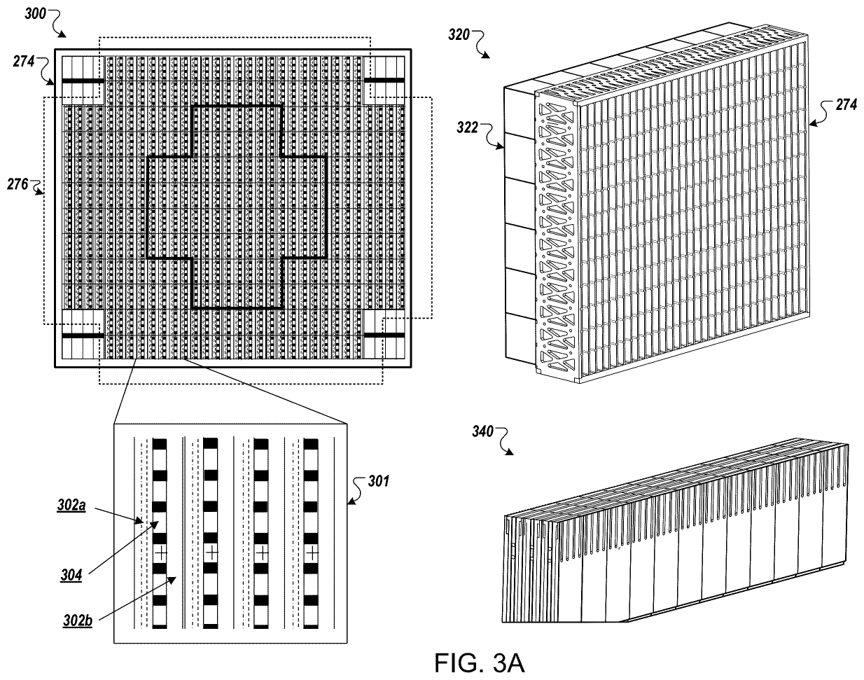

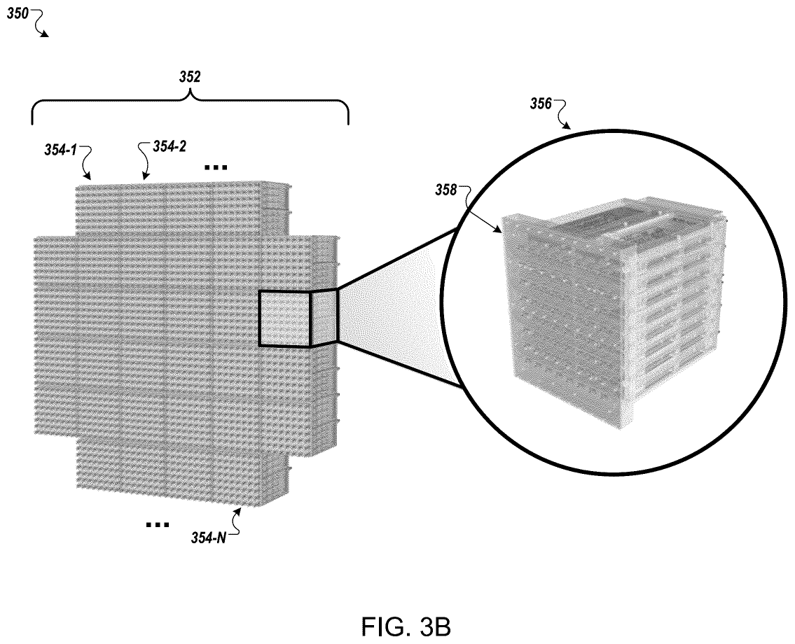

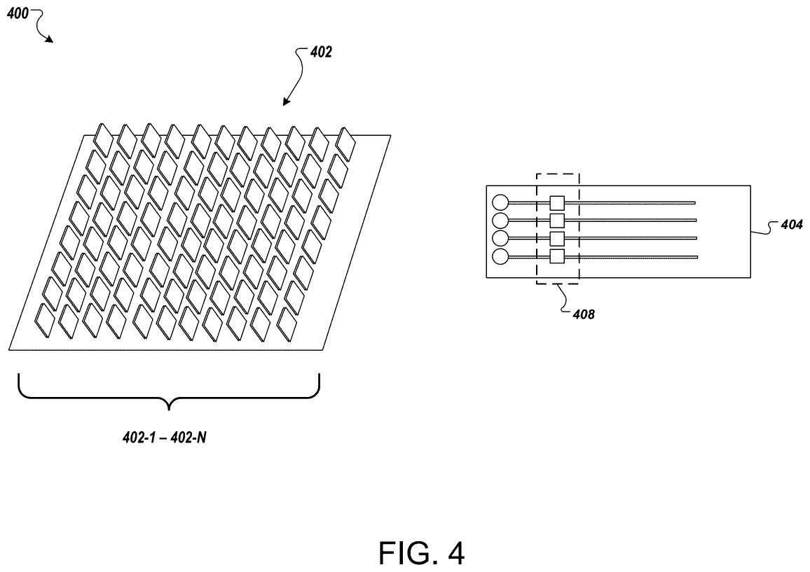

FIG. 2A illustrates an example block diagram 200 of a multi-purpose radar system 102, emitting a transmit beam 203 to obtain detections for object 201 through a receive signal 205. The diagram 200 includes a radome 202 for the multi-purpose radar system 102, which can enclose an active electronically scanned array (AESA), also referred to as an “AESA antenna” configured to transmit and receive RF signals, such as transmit signals for transmit beam 203 and receive signals for receive beam 205. The multi-purpose radar system 102 includes the radome 202 to protect components of the AESA antenna, e.g., transmit/receive modules, from an environment of the multi-purpose radar system (e.g., precipitation, debris), while allowing RF signals to pass through the radome 202. Additional details relating to the subarrays of the AESA antenna and transmit/receive modules are described in reference to FIGS. 3A, 3B, and 4 below.

The diagram 200 shows the multi-purpose radar system 102 having a radar backend system 204, an auxiliary subsystem 252, and a power supply 266. The radar backend system 204 of the multi-purpose radar system includes a control subsystem 206, a digital processing subsystem 208, and an analog-to-digital subsystem 210. Components of each subsystem can be stored (e.g., enclosed) in radar hardware, such as a power supply rack 210, a radar rack 228, and a computer rack 214. Subsets of components can be configured to operate as a particular subsystem for the radar backend system 204 of the multi-purpose radar system 204. For example, the digital signal processing subsystem 208 and the analog-to-digital subsystem 210 can have components sharing the same enclosure, e.g., the radar rack 228.

The digital signal processing subsystem 208 includes digital processing elements such as graphical processing units (GPUs) 232 for data processing and a memory subsystem 207 that includes memory devices for data storage. The digital signal processing system includes GPUs 232 (e.g., general-purpose GPUs for computing) that perform algorithms (e.g., algorithms 227 of the control subsystem 206) associated with an application of the multi-purpose radar system 102. The memory subsystem 207 stores radar data, such as detections received from objects in a range window. As an example, the range window can be over 100 km in range (e.g., providing a significant amount of data to be stored, processed, etc.) with data from the range window processed at full-bandwidth (e.g., compared large range windows processed with narrow bandwidths). The memory subsystem 207 stores radar data, e.g., a record of transmitted waveforms and related waveform data, received detections, processing results from the GPUs 232, for the GPUs 232 of the digital signal processing subsystem 208 to access. As an example, the GPUs 232 can access the memory subsystem 207 to perform trillions of floating-point operations per second, thereby enabling the multi-purpose radar system 102 to execute complex algorithms with significant processing demands.

The GPUs 232 of the digital signal processing subsystem 208 can perform improved detection processing using lower SNR detection thresholds and sophisticated constant false alarm rate algorithms to acquire and track objects. By processing detections with lower SNR detection thresholds, the multi-purpose radar system 102 can detect smaller targets with complex geometries and high degrees of maneuverability, e.g., hypersonic glide vehicles, drones. The GPUs 232 of the digital signal processing subsystem 208 also support the multi-purpose radar system 102 to perform multiple applications simultaneously by processing datasets stored in the memory devices in the memory subsystem 207. Datasets in the memory devices can include received detections from the range windows generated by the multi-purpose radar system 102, which can be extensive due to the improved range resolution and bandwidth provided by the array hardware, as described in FIG. 2B below. For example, detections associated with a transmitted waveform of the multi-purpose radar system 102 can be partitioned into multiple datasets, each dataset corresponding to a different algorithm and application that are simultaneously performed, executed, processed, etc. In some implementations, the GPUs 232 can be directed by the control subsystem 206 of multi-purpose radar system 102 to perform processing of datasets that can be obtained in response to a scheduled waveform (e.g., queueing the GPUs 232 to prepare for a next application different than the current application performed).

The digital signal processing subsystem 208 may utilize the GPUs 232 to perform complex algorithms such as digital beamforming, electromagnetic interference (EMI) mitigation, and transmit beam spoiling. For example, the subarrays of the multi-purpose radar system 102 can simultaneously process multiple receive beams, e.g., returns from multiple objects, thereby providing a decrease in beam-shape loss (e.g., due to overlapping beams) and an increase in sensitivity to detect smaller targets with low RCS values at longer ranges. Digital beamforming enabled by the GPUs 232 also provides improved angle estimation algorithms (e.g., maximum likelihood estimation) to improve angle measurement accuracy and resolution, to determine direction of arrival for detected objects (e.g., weather fronts, vehicles, drones). Digital beamforming also enables multiple receive beams (e.g., multiple receive beams 205) to provide a larger detectable volume surrounding the transmit beam to improve object tracking (e.g., for close-range targets). In some implementations, the digital signal processing subsystem 208 of the radar backend system 204 can be configured as a digital-to-analog subsystem that uses the GPUs 232 to generate arbitrary waveforms, e.g., for transmit beam 203. The digital-to-analog subsystem can be modular and replaced by alternative digital-to-analog subsystems depending on algorithms performed for a particular application.

The GPUs 232 may perform EMI mitigation by generating and providing complex, difficult to detect arbitrary waveforms (e.g., preventing EMI sources from jamming or replaying transmit signals) for the subarrays of the multi-purpose radar system 102 to transmit. In some implementations, the GPUs 232 may process sets of radio frequency (RF) data from the subarrays and detect a presence of EMI. In response to detecting EMI in the RF data, the GPUs 232 may switch to a different processing algorithm (e.g., an algorithm from the algorithms 227) and/or adjust algorithm parameters to mitigate the detected EMI. The GPUs 232 may also perform EMI mitigation by dedicating resources to generate transmit beams that suppress EMI by placing null beams in the direction of the detected EMI. As another example, the GPUs 232 may perform EMI mitigation identifying jammed portions of received RF detections and excising the identifying portions. The GPUs 232 may also perform EMI mitigation by adjusting waveforms and processing logic (e.g., algorithms 227) for the adjusted waveforms and evaluate mitigation performance to determine if further adjustments are necessary.

The GPUs 232 may also perform processes such as transmit beam spoiling, digitally processing multiple receive beams, and improved bandwidth/resolution due to the modular components of the transmit/receive modules. For example, the transmit beam spoiling can be achieved by adjusting the phase-shifter settings within transmit/receive modules (further described in reference to FIG. 4 below) of the subarrays. The GPUs 232 can process multiple receive beams digitally, e.g., the receive beams sampled by high-speed sampling analog-to-digital converters 247 (also referred to as “A/D converters 247”) of the analog-to-digital subsystem 210. Digital processing of the receive beams by the GPUs 232 ensures that significant amounts of high-resolution radar data can be used to generate results in various types of applications simultaneously (e.g., high resolution data for defense application, lower resolution data for commercial applications). As another example, the improved bandwidth and resolution provided by the digital-to-analog subsystem (e.g., by high-speed sampling digital-to-analog converters 249) and components of the transmit/receive modules provide high-fidelity data for the GPUs 232 to process. The GPUs 232 provide significant processing resources for the multi-purpose radar system 102 to execute target tracking (e.g., a defense type of application that may desire high resolution data for improved performance and accuracy) while performing other types of applications without degrading results for other types of applications such as wirelessly communicating to a command and control center.

The digital signal processing subsystem 208 can also include a signal processor 234 and a data processor 236 that can perform algorithms in response to functions performed by multi-purpose radar system 102. For example, the multi-purpose radar system 102 can schedule functions such as transmitting and receiving waveforms (e.g., using the subarrays), and multiple beam generation and formation (e.g., by the electronically steered transmit/receive elements). In response to receiving data (e.g., radar detections) by performing functions such as transmitting and receiving waveforms, the multi-purpose radar system 102 can provide the data to the signal processor 234 and the data processor 236 to perform multiple algorithms at the same time (e.g., simultaneous algorithm processing). The signal processor 234 and data processor 236 can perform the algorithms corresponding to multiple types of applications in parallel, to provide multiple sets of processed output data to the multi-purpose radar system 102 to perform the multiple types of applications. In order words, the multiple sets of processed output data (e.g., tracks and characterizations of detected objects) generated by the signal processor 234 and the data processor 236 can be provided to the multi-purpose radar system 102 to fulfill multiple types of applications (e.g., commercial, defense) simultaneously.

The digital signal processing subsystem 208 can include additional radar hardware such as network switches 230, transmit local oscillator 233, a power distribution unit 235, and a compact converter radio frequency up/down converter 237, an uninterruptible power supply/automatic voltage regulator 238. The radar rack 228 of the radar backend system 204 also includes a receiver-exciter enclosure 240, a radio frequency power combiner/splitter (PCS) PCS 244, and the high-speed sampling digital-to-analog converters 249 (also referred to as “D/A converters”) described above. The RF PCS 244 can be configured to distribute RF signals for transmit from a digital-to-analog converter (e.g., an exciter) to the subarrays of transmit/receive modules (e.g., antenna elements). The RF PCS 244 can also be configured to combine received RF signals from the transmit/receive modules of the subarrays to analog-to-digital converters (e.g., a receiver).

The radar rack 228 can include a transmit local oscillator 233 with RF Up/Down converters 237 to convert intermediate frequency signals generated by the high-speed sampling digital-to-analog converters 249 to RF frequencies. For example, the digital-to-analog conversion can include generating signals ranging 550 MHz to 950 MHz, in which the RF Up/Down converters 237 convert the signals for transmit by the antenna elements at a C-band frequency, e.g., 5.25 GHz to 5.65 GHz. In more detail, the high-speed sampling D/A converters 249 can be stored in a REX enclosure 240, and signals from conversion by the converters can be processed through the PCS 244, to be provided for transmit by the subarrays (e.g., through T/R modules). The high-speed sampling A/D converters 247 can also be stored within the REX Enclosure 240, and process received analog signals from one or more detected objects. For example, received signals from the PCS 244 can be processed through the RF Down-Converters 246 and digitized for further processing by the signal processor 234 (e.g., applying pulse compression techniques, algorithms, and other techniques for forming radar detections from radar returns, etc.) and the data processor 236 (e.g., level algorithms for analyzing processed RF detections).

The multi-purpose radar system 102 includes the control subsystem 206 to adjust operation of the digital signal processing subsystem 208 and process data stored in the memory subsystem 207. The control subsystem 206 can direct the digital signal processing subsystem 208 to process RF detections using an algorithm from algorithms 227 corresponding to an application to a different algorithm corresponding to a different application. The control subsystem 206 can adjust operation of the digital signal processing subsystem 208 to apply different processing algorithms 227 corresponding to different applications over consecutive operational cycles (e.g., processing cycles) of the radar. For example, the control subsystem 206 can direct the digital signal processing subsystem 208 to apply algorithms 227 for a first application (e.g., object tracking) and perform a different set of algorithms corresponding to a second application (e.g., weather monitoring).

Additionally, the control subsystem 206 can pre-emptively and responsively select one or more algorithms from the algorithms 227 for the digital signal processing subsystem 208 to perform for applications in subsequent operational cycles. In some implementations, the control subsystem 206 selects one or more algorithms to process RF detections for a different application (e.g., of the same type, or a different type) to be performed while processing received RF detections for a current application performed by the multi-purpose radar system 102, e.g., applying algorithms associated to the current application for the received RF detections. In some implementations, the control subsystem 206 may direct the digital signal processing subsystem 208 to perform multiple applications simultaneously by cycling between two or more algorithms from the algorithms 227 over consecutive operational cycles. As another example, the control subsystem 206 may switch from a searching or tracking algorithm (e.g., performing object detection and tracking) to an algorithm for communicating data wirelessly (e.g., providing the object track results and data to another remote device). In some implementations, the control subsystem 206 of the multi-purpose radar system 102 can integrate results of one or more processing algorithms with processing results received from one or more other multi-purpose radar systems to ensure time and phase alignment coherency.

The control subsystem 206 includes network switches 216, data storage 218, in-phase and quadrature computer 220, a power distribution unit 222, a mission computer 224, and a programmable logic controller (PLC) 226. In some implementations, components of the control subsystem also include components of the antenna subsystem, e.g., antenna subsystem 272 described in reference to FIG. 2B below. The network switches 216 can be configured to couple different components of the radar system, e.g., as part of a network infrastructure for the radar system. The data storage 218 can be configured to store data for the radar system 102, e.g., raw pre-processed data, processed data. The in-phase and quadrature computer 220 can be configured to display, provide, analyze, in-phase and quadrature components from received radar signals. The mission computer 224 can be a computing device for mission planning and can serve as a communication interface, e.g., to a command and control interface 162 of FIG. 1B and other interfaces such as weather interface 152. The PLC 226 can be configured to perform data acquisition and monitoring, environmental control (e.g., temperature, pressure, power supply), power management, maintenance and diagnostics, etc.

Although FIG. 2A depicts dashed-boxes arranging subsets of components of the radar backend system 204 to form the control subsystem 206, the digital signal processing 208, and analog-to-digital subsystem 210, the components of the radar backend system 204 can be configured for other arrangements. In some cases, different subsystems can share one or more components, including multiple subsets of components. For example, components of the control subsystem can include hardware stored in radar racks of the antenna subsystem, e.g., radar racks 281 described in reference to FIG. 2B below. In some implementations, radar rack 228, computer rack 214, and other types of enclosures, (e.g., including physical arrangements of the radar hardware) can be configured to form different subsystems. For example, a digital-to-analog subsystem can be configured using the high-speed sampling digital-to-analog converts 249, but can also include other components of the radar racks 228 and 281, and/or computer rack 214.

As depicted in FIG. 2A, the multi-purpose radar system 102 includes the auxiliary subsystem 252, which further includes a transfer switch 254, a low-power genset 256, a shore power hook-up 258, a cooling subsystem 260, an autostart/UPS 262, and one or more standby subsystems 264. Examples of standby subsystems 264 can include lighting devices, alarms, security cameras, and other types of peripheral devices.

The auxiliary subsystem 252 can be configured to draw power from the power supply 266 to provide power to the radar backend system 204. Examples of the power supply 266 can include a diesel generator. Components of the auxiliary subsystem 252 can be configured to provide power and cooling to the system 102. The auxiliary subsystem 252 can be configured to provide operating power to the radar hardware (e.g., electronics, transmit/receive elements), for transmitting and receiving of radio frequency signals. For example, the low-power genset 256 can be configured to provide auxiliary power for computing devices and lighting devices of the radar system. The shore power hook-up 258 can be configured to connect to an external (e.g., high power) power supply 266, and the transfer switch 254 can be configured to switch to the external high power supply (e.g., an electric power grid, high-power generator). The autostart/UPS 262 maintains power to the computing devices of the radar system 102, e.g., in case of an outage for a primary power supply source of the radar system. In this way, the autostart/UPS 262 allows for a smooth power-down of the radar computing devices. The auxiliary subsystem 252 can also be configured to provide cooling to the radar hardware. For example, the cooling subsystem 260 provides chilled coolant to the radar antenna. Standby subsystems include lights, alarms, security cameras, etc.

The multi-purpose radar system 102 can dynamically (e.g., in real-time) adjust operations (e.g., processing) to support different types of applications. For example, the multi-purpose radar system 102 can allocate resources (e.g., the GPUs 232 of the digital signal processing subsystem 208) for supporting a first type of application (e.g., commercial) and adjust the amount of resources to support a different type of application (e.g., defense). The multi-purpose radar system 102 can adjust processing demands (e.g., applying algorithms 227 to the RF detections) based on the application type, e.g., prioritizing support provided to a particular application type depending on factors such as mission priority and the environment, e.g., environment 100 described in reference to FIG. 1A above. In some implementations, dynamic operation of the multi-purpose radar system 102 can also include adjusting waveforms and beam placements of transmit beams (e.g., from subarrays of an AESA antenna enclosed in the radome 202) based on an application type. As another example, the multi-purpose radar system 102 can allocate resources and adjust operations of any of the subsystems without interrupting current application type processing, e.g., providing smooth transitions in processing loads between different application types.

Referring to FIG. 2A, the multi-purpose radar system 102 includes the analog-to-digital subsystem 210 to receive analog output (e.g., analog signals) from the subarrays and stores a digital representation (e.g., digitizing analog signals into digital signals) into the memory subsystem 207. For example, the analog-to-digital subsystem 210 includes analog-to-digital converters 247 that sample the received analog signals (e.g., representing detections from detected objects) to generate digital signals, which can be processed by the GPUs 232 of the digital signal processing subsystem 208. As an example, the analog to digital converters 247 can perform high-speed (e.g., 10 Gigabits per second) sampling with an RF signal from the subarrays to generate a digital signal. The high-speed sampling from the analog to digital converters 247 enables the multi-purpose radar system 102 to process high-resolution using the digital signal processing subsystem 208.

Each application of the multi-purpose radar system 102 can utilize different respective processing algorithms and techniques, all of which can be performed by multi-purpose radar system 102 simultaneously. The multi-purpose radar system 102 can perform different applications simultaneously using the same set of radar data (e.g., by collecting a range window of data and storing in the memory subsystem 207) and applying multiple algorithms on the radar data to perform the respective applications. The digital signal processing subsystem 208 of multi-purpose radar system 102 can execute algorithms for two or more applications without compromising performance of an existing operation that the multi-purpose radar system 102 is performing, e.g., processing data for weather monitoring while tracking potential threats in airspace.

The multi-purpose radar system 102 can allocate resources in response to detected conditions of the environment 100. For example, the multi-purpose radar system 102 can identify obstructions (e.g., hills, wind turbines) in the environment 100. The control subsystem 206 can configure the subarrays to skip transmission of beams in the direction of the identified obstructions to achieve computational savings, e.g., thereby providing resources for other applications and higher computational efficiency. The multi-purpose radar system 102 can determine application prioritization based on the monitored conditions and continue processing algorithms for a high priority application while disabling processing algorithms (e.g., algorithms 227) for other applications. In some implementations, the multi-purpose radar system 102 can perform a subset of processing algorithms from the algorithms 227 for the digital signal processing subsystem 208 based on detected conditions (e.g., visibility, application priority, geography, weather). The multi-purpose radar system 102 can determine amounts of processing time to be allocated for each application performed, providing guidance to the digital signal processing subsystem 208 based on application priority. The real-time resource allocation performed by the multi-purpose radar system 102 may include dedicating portions of any of the subsystems to a particular application while halting or de-prioritizing applications (e.g., to perform later, with fewer resources, etc.) The multi-purpose radar system 102 may adjust operation of the digital signal processing subsystem 208 to stop processing RF detections for some applications while initiating processing for other applications. In some implementations, the control subsystem 206 of the multi-purpose radar system 102 can dedicate some of the subarrays to receive detections for one application while the remaining subarrays are dedicated to detections received for another application. In another example, the control subsystem 206 can adjust processing demands of the digital signal processing subsystem 208 based on available radar resources and demands, e.g., switching algorithms, scheduling algorithms to process RF detection based on application priority. The subarrays of the multi-purpose radar system 102 can be dedicated to schedule pulses for different applications. In some implementations, the control subsystem 206 can responsively reconfigure antenna weights of a subarray, due to a malfunction or other detected conditions of an environment (e.g., environment 100 of FIG. 1A) to continue providing reliable performance of one or more applications.

FIG. 2B illustrates an example block diagram 270 for an AESA antenna 276 of a multi-purpose radar system 102. The diagram 270 depicts an antenna subsystem 272, which is enclosed by the radome 202 depicted in FIGS. 2A and 2B. The antenna subsystem 272 includes an AESA panel 274, which serves as a framework to arrange transmit/receive modules for the AESA antenna 276. Further description of the AESA panel 274 is described in reference to FIG. 3A below. The AESA Antenna 276 includes a number of subarrays 277-1-277-N (collectively “subarrays 277”), each subarray including transmit/receive (TR) modules 278. Each TR module from the TR modules 278 includes a number of elements 279-1 through 279-N (collectively “elements 279”) and a number of power amplifiers 280-1 through 280-N (collectively “power amplifiers 280”). Further description of the elements 279 and 280 are described in reference to FIG. 4 below. The AESA panel 274 also includes a global navigation satellite system (GNSS)/inertial measurement unit (IMU) 275 (depicted as “GNSS/EIU 275” in FIG. 2B).

The subarrays 277 of the multi-purpose radar system 102 are scalable (e.g., to achieve any desired antenna size) and modular (e.g., to be customized for any application), as described in FIGS. 3A and 3B below. The hardware and software architectures of the subarrays 277 can enable the multi-purpose radar system 102 to perform applications such as distributed radar networking and wireless communications by aggregating power and transmission rates across an entire network of radar systems, each radar system being a multi-purpose radar system. FIG. 2C shows an example environment 290 of a distributed network 291 (also referred to as “network 291”) of multi-purpose radar systems, e.g., a first multi-purpose radar system 102 from FIG. 1A and additional multi-purpose radar systems 292-1 through 292-N. The distributed network 291 of multi-purpose radar systems can provide improved reliability and radar performance. For example, the distributed network 291 of multi-purpose radar systems can communicate with one or more systems (e.g., command and control centers) to provide data (e.g., processed RF detections, track data, classification data) to the one or more systems.

For example, the commonality and sharing of similar hardware and software architectures enables multiple radar systems to operate as a network. Each radar system of the network 291 is an example multi-purpose radar system 102, providing an overall antenna array 294 from all of the subarrays across all of the multi-purpose radar systems. The overall antenna array 294 provides wider coverage (e.g., compared to a single multi-purpose radar system) of an environment (e.g., environment 100) with improved range and angular resolution. The overall antenna array 294 also provides multiple perspectives (e.g., profiles) of objects detected by the distributed radar network to track the detected objects with a higher degree of confidence. The distributed radar network 291 also provides that the power of the subarrays for each multi-purpose radar system can be aggregated for improved performance. As another example, the distributed radar network 291 can use aggregate transmission power across all of the multi-purpose radar systems to achieve high data rates to other systems (e.g., command and control centers).

Referring to FIG. 2B, the antenna subsystem 272 includes a number of radar racks 281-1 through 281-N (collectively “radar racks 281”), in which each radar rack from the radar racks can be an electromagnetic interference (EMI) shielded enclosure, e.g., providing electromagnetic shielding to the components of the antenna subsystem 272 enclosed by the radar racks 281. The radar racks 281 can be configured to house radar hardware (including any radar software) to support operation of the antenna subsystem 272. For example, the radar racks 281 can include network switches 282, a controller area network (CAN) bus 283, Ethernet 284, a master timing unit 285, UPS/AVR 286, a power distribution unit (PDU) 287, a frequency distribution chassis 288, and a grand master clock 289. The radar hardware of the radar racks 281 can be configured to provide digital control signals (e.g., through the master timing unit 285 and the grand master clock 289) for the radar system 102, read operational status of components (e.g., through the CAN bus 283), and distribute powers to the subarrays (e.g., through PDU 287). The frequency distribution chassis 288 can be configured to house hardware for synthesizing, allocating, managing, frequencies of signals for the system 102. The master timing unit 285 can be configured to generate and distribute timing signals for synchronizing operation between different components of the radar system 102, which can include using the grand master clock 289 as a time reference. The grand master clock 289 can be a clock source based on a type of oscillator, e.g., as a primary time reference, and can be a reference time source external to the radar system 102, e.g., global positioning system.

FIG. 3A depicts various views of an AESA antenna and AESA panel (e.g., AESA antenna 276 and AESA panel 274, referring to FIG. 2B above) of a multi-purpose radar system 102. For example, a front view 300 shows the AESA panel 274, which further includes AESA antenna 276, as being enclosed by a region with a dashed line. The front view 300 shows the AESA panel 274 having rows and columns of TR modules arranged as the AESA antenna 276. In particular, each column of TR modules includes a cold plate adjacent to either side of the column of TR modules. For example, a callout 301 depicts a column of TR modules 304 interspersed between a pair of cold plates 302a and 302b. The first cold plate 302a shown in callout 301 is to the left of the column of TR modules 304, while the second cold plate 302b is to the right of the column of TR modules 304. The cold plates of the antenna 276 draw heat away from electronics (such as antenna elements and power amplifiers/transmitters) to provide cooling and prevent overheating of the electronics, e.g., reducing a likelihood of faults occurring in the electronics and/or reducing a severity of a fault in the electronics. In some implementations, the cold plates 302a and 302b utilize liquid cooling techniques to cool the electronics of the AESA antenna 276.

In some implementations, portions of the array 276 can be unpopulated (e.g., a TR module does not need to be installed in every portion of the AESA panel 274), such as the portion 275 depicted in view 300. In some implementations, a subset of the TR modules in the AESA antenna 276 can be configured with high-power power amplifiers/transmitters relative to the remaining portion of the TR modules. As an example, the subset of TR modules can be located in a central position depicted in the front view 300 of the AESA antenna 276. This configuration and arrangement of high-power transmit/receive elements (e.g., with high-power amplifiers) can be desirable for applying a Taylor weighting of transmitted waveforms to achieve lower sidelobes, by having a higher power output in a centrally located position of the AESA antenna 276 (e.g., corresponding to a mainlobe indicating a detection of an object in UV space). The relatively lower power TR modules away from the centrally located position of the AESA antenna 276, the resulting sidelobes from the detected object can be lower in magnitude (e.g., values for radar-cross section).

FIG. 3A also depicts a perspective view 320 of the AESA panel 274, which further includes the AESA antenna 276. The perspective view 320 shows a support frame 322, which can be coupled to the AESA panel 274 to secure the panel to a support structure, e.g., providing rigidity to hold the TR modules of the AESA antenna 276 in alignment. FIG. 3A depicts a cross-section view 340 of the pair of cooling plates 302a and 302b, showing the column of TR modules 304 interspersed between the pair of cooling plates 302a and 302b.

FIG. 3B illustrates an example AESA antenna 352 (e.g., without a radome) for a multi-purpose radar system 102, in which an antenna 352 includes subarrays 354-1-354-N (collectively referred to as “subarrays 354” for brevity.) A subarray 354 can include any number of electronically steered transmit/receive elements, e.g., radiating elements. As an example, a multi-purpose radar system 102 can include 32 subarrays that each include an 8 by 8 array of radiating elements (i.e., 64 elements per subarray, for a total of 2048 elements from all 32 subarrays). In some implementations, the multi-purpose radar system 102 can include different arrangements (e.g., 1 by 4 array, 2 by 4 array) of radiating elements in a respective subarray 354. Each of the subarrays 354-1-354-N can be configured to capture a wide portion of the RF spectrum, e.g., using 400 MHz bandwidth. An example subarray 356 is illustrated for reference. As an example, the scalable subarrays using modular radar hardware can provide small configurations (e.g., 2×2 subarray) for some applications such as drone tracking, in which the small configuration could be elevated and configured to track drones. Expanding the subarrays to a larger configuration (e.g., 6×8 subarray), with each subarray using the same modular hardware, can enable more challenging applications such as tracking hypersonic glide vehicles.

The antenna 352 of the multi-purpose radar system 102 has a scalable design that enables different configurations for antenna sizes (e.g., larger, smaller) by using any number of subarrays 354-1-354-N. The scalable antenna array enables the multi-purpose radar system 102 to perform different missions (e.g., application types) that can depend on a particular antenna sizes (e.g., corresponding to a desired range resolution). For example, the multi-purpose radar system 102 includes a first number of subarrays (e.g., 4 subarrays such as subarrays 354-1-354-4) that achieves a desired detection range for an application requiring a particular detection range, e.g., aircraft detection. The multi-purpose radar system 102 can achieve an improved detection range (e.g., increased detection range to detect smaller radar cross section targets) that can be required for another application (e.g., detecting drone swarms and hypersonic glide vehicles) by adding additional subarrays to the multi-purpose radar system 102, thereby increasing the overall antenna size. Adding additional subarrays also increases transmit power (e.g., radiating power) and transmit aperture (e.g., antenna directivity) to enable the antenna 352 with an increased detection range to detect small objects (e.g., with small radar cross sections) that may be difficult to detect otherwise (e.g., compared to a radar with fewer subarrays or a fixed number of subarrays).

Furthermore, a subarray 356 can be configured to independently transmit and receive beams. As an example, a subset of the subarrays 354 can be directed by a control subsystem 206 and a digital signal processing subsystem 208 of multi-purpose radar 102 to perform one application, while another subset of subarrays 354 can be directed to perform a different application. As discussed in FIG. 2A above, each subarray may be scheduled and prioritized to perform various applications in response to monitored conditions (e.g., an environment, a command and control center, etc.) Each subarray includes a number of channels that can be configured to steer a set of beams in multiple directions through the digital signal processing subsystem 208 of the multi-purpose radar system 102.

The hardware and software architecture of the multi-purpose radar system 102 provides that the multi-purpose radar system 102 can be deployed as a standalone system, as well as in conjunction with other radar systems (e.g., including multiple multi-purpose radar systems 102). The scalable design of the antenna 352 also provides portability to the multi-purpose radar system such that the antenna 352 can be affixed to a structure (e.g., wind turbines) for particular applications such as mitigating wind turbine interference. In some implementations, the antenna 352 can be attached to a vehicle (e.g., motor vehicles, aircraft) for mobile operation and processing of received RF detections.

As an example, a wind farm with multiple wind turbines may generate interference when transmitted beams of a radar system are placed in a direction towards the wind farm. The multi-purpose radar system may dedicate one or more subsystems and the subarrays to map the generated interference from the wind farm. The interference data generated by the multi-purpose radar system 102 can be provided to other radar systems to remove affected waveforms for the other radar systems. In some implementations, the multi-purpose radar system 102 can use the interference data to improve its own radar performance, by adjusting parameters and algorithms in the digital signal processing subsystem 208, and/or refining detections stored in the memory subsystem 207.

In addition to scalability, the modularity of the subarrays 354 provide that the multi-purpose radar system 102 can be customized for the various applications disclosed herein. For example, a front panel 358 of subarray 356 may be removed and each of the radiating elements (e.g., transmit/receive modules) may be removed, reconfigured, adjusted, etc. Further description of subarray modularity is discussed in reference to FIG. 4 below.

The module design of the multi-purpose radar system 102 allows it to be readily scaled up to whatever applications or purposes are needed. As illustrated in FIG. 3B, the AESA antenna 352 has 32 sub-arrays working together, with each subarray having tens or hundreds of transmit/receive elements.

Even when using a subset of such subarrays (e.g., eleven subarrays), the resulting system is powerful enough to simultaneously perform applications for air traffic control and surveillance of aerial targets with no degradation. In this context, performing an application with no degradation means that the radar is able to achieve the same performance as when performing only one single application.

FIG. 4 illustrates an example subarray system 400 with an antenna subarray 402 that includes antenna elements 402-1-402-N. The antenna subarray 402 can be configured to include any number of antenna elements, which can be based on an application performed by a multi-purpose radar system. The example subarray system 400 also includes a quad transmit/receive module (TRM) 404 on an RF printed circuit board (PCB). The example subarray system 400 can include any number of quad TRMs 404, as well as a number of RF PCBs corresponding to each quad TRM 404. The modular design of the system 400 allows for the RF PCBs to have, or to lack, power transmitters 408. For example, each RF PCB can include power transmitters 408, which can be configured by a control subsystem 206 of a multi-purpose radar to adjust the amount of power in a transmitted signal. In some implementations, the power transmitter 408 can be removed for applications that may only perform receive-only signal processing, e.g., by a digital signal processor of the multi-purpose radar system. Some reconfigurations (e.g., removing power transmitters 408, adjusting antenna weights of the antenna elements 402-1-402-N) of the antenna subarray 402 can be a physical adjustment of hardware (e.g., performed in a factory), while other reconfigurations are performed by software (e.g., by the digital signal processing subsystem 208 and the control subsystem 206) of a multi-purpose radar system.

The antenna weights of antenna elements 402-1-402-N can be reconfigured to enable a graceful transition (e.g., degradation) of object tracking and detection. For example, an object can continue being tracked by a subarray (e.g., subarray 356 referring to FIG. 3B) with less transmitted power from the antenna elements, without dropping below a detection threshold required to maintain tracking of the object. The antenna subarray 402 can be detached from a subarray (e.g., subarray 356) to access the quad TRMs 404 of the subarray. By separating the antenna subarray 402 from the quad TRMs 404, each of the quad TRMs 404 can be configured to have a different polarization from one another (e.g., adjusting the radiating antenna pattern to provide a different transmit polarity). For example, a dual polarization configuration can be provided by reconfiguring the antenna weights to perform receive-only operations, e.g., a receive only panel of the multi-purpose radar system, after transmitting pulses in a first polarity. The receive-only panel receives an opposite polarity (e.g., with respect to the first polarity of the transmitted pulses) from a detected object, thereby receiving data to be processed by a digital signal processing subsystem 208. For example, a signal processor and data processor can receive data from the multi-purpose radar system in a dual-polarization configuration to perform algorithms tailored towards dual-polarization applications (e.g., detecting precipitation).

Diverse polarization configurations using the quad TRMs 404 enable the subarray to further extract and identify different features of detected objects. For example, one type of polarization such as dual polarization may be preferred for a first application with potential targets are relatively small, e.g., detecting precipitation, whereas another type of polarization such as single polarization may be preferred for an application with potential targets that are relatively large, e.g., planes for air traffic control. As an example, the quad TRMs 404 of the multi-purpose radar system can be reconfigured such that the multi-purpose radar system is dually polarized on receive but singularly polarized on transmit. The reconfigurability of the quad TRMs 404 provides multiple polarization schemes that can be performed by the multi-purpose radar system, thereby tailoring the multi-purpose radar system to fulfill particularly desirable applications.

A quad TRM 404 can include a number of layers and components, such as an aluminum casing, a thermally and electrically conductive adhesive film, an RF PCB and a microcontroller PCB to control operation of the RF PCB from a control subsystem 206 of the multi-purpose radar system.

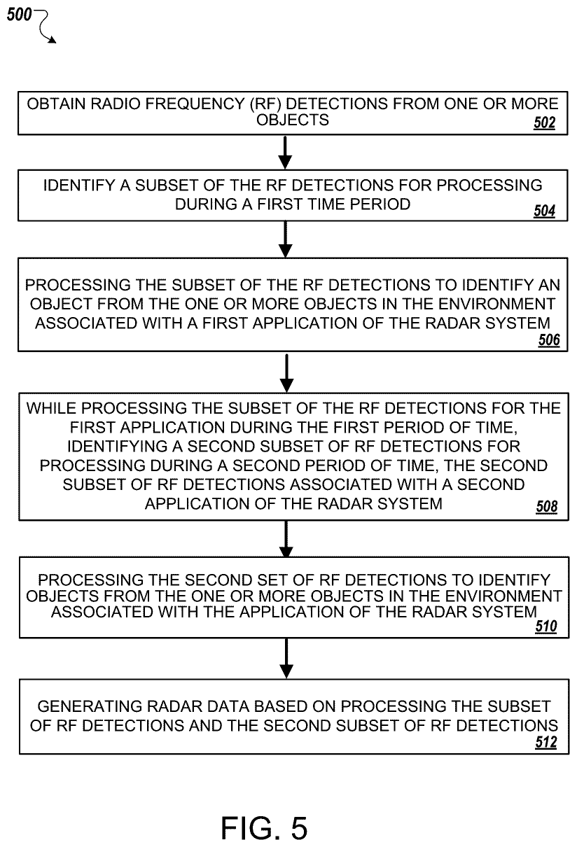

FIG. 5 illustrates an example process 500 performed by a multi-purpose radar system, e.g., multi-purpose radar system 102. Briefly, the process 500 includes obtaining radio frequency (RF) detections from one or more objects (502), identifying a first subset of the RF detections for processing during a first time period (504), processing the first subset of the RF detections to identify an object from the one or more objects in the environment associated with a first application of the radar system (506), while processing the first subset of the RF detections for the first application during the first period of time, identifying a second subset of RF detections for processing during a second period of time, the second subset of RF detections associated with a second application of the radar system (508), processing the second set of RF detections to identify objects from the one or more objects in the environment associated with the application of the radar system (510), and generating radar data based on processing the subset of RF detections and the second subset of RF detections (512).

The process 500 includes obtaining, by an antenna array of the radar system, radio frequency (RF) detections from one or more objects (502). In some implementations, the antenna array of the radar system can include one or more subarrays of electronically steered transmit/receive elements. The one or more subarrays of electronically steered transmit/receive elements of the multi-purpose radar system are configured to capture a wide portion of the RF spectrum. The multi-purpose radar system can include an analog-to-digital subsystem configured to receive the analog output of the one or more subarrays and to store a digital representation of the analog output into a memory subsystem.

The process 500 includes identifying, by a digital signal processing subsystem of the radar system, a first subset of the RF detections for processing during a first time period (504). The digital signal processing subsystem can include a plurality of digital processing elements and the memory subsystem. The memory subsystem can include one or more memories, e.g., RAM, DRAM, data storage, among other types of computing memory. In some implementations, the plurality of digital processing elements are graphics processing units, and the memory subsystem is one or more integrated memories of the graphics processing units. In some implementations, the memory subsystem is configured to store an entire range window of data over a wide portion of RF spectrum. The range window stored by the memory subsystem can be over 100 km of range and can be processed at full bandwidth of the multi-purpose radar system.

The process 500 includes processing, during the first period of time and by the digital signal processing subsystem of the radar system, the first subset of the RF detections to identify an object from the one or more objects in the environment associated with a first application of the radar system (506). In some implementations, the process 500 includes directing, by a control subsystem, the digital signal processing subsystem to perform a plurality of different processing algorithms on the data stored in the memory subsystem.

The process 500 includes processing the first subset of the RF detections for the first application during the first period of time, identifying a second subset of RF detections for processing during a second period of time, the second subset of RF detections associated with a second application of the radar system (508). The multi-purpose radar system can be configured to perform at least one type of application simultaneously.

The process 500 includes processing the second set of RF detections to identify objects from the one or more objects in the environment associated with the application of the radar system (510). In some implementations, the multi-purpose radar system is configured to simultaneously perform two or more of the following applications: aircraft detection, aircraft tracking, communications, weather monitoring, or interceptor guidance.

The process 500 includes generating radar data based on processing the subset of RF detections and the second subset of RF detections (512). The multi-purpose radar system can perform the process 500 to simultaneously perform multiple different applications having different respective processing algorithms, each of the multiple different applications correspond to a different type of application. In some implementations, simultaneously performing multiple different applications includes directing the digital signal processing subsystem to perform multiple different processing algorithms on the same set of data stored in the memory subsystem. In some implementations, simultaneously performing multiple different applications includes directing the digital signal processing subsystem to perform multiple different processing algorithms over consecutive operational cycles of the radar. In some implementations, simultaneously performing multiple different applications includes cycling between two or more processing algorithms over consecutive operational cycles of the radar.

The control system of the multi-purpose radar system can be configured to dynamically select a next processing algorithm for a next application on each operational cycle. In some implementations, the control subsystem is configured to select a next processing algorithm while digital signal processing subsystem is processing data for a current processing algorithm. In some implementations, the control system is configured to perform a real-time resource allocation process to determine which resources to allocate to each of the multiple different application types. The process 500 can include performing the resource allocation process can include determining an amount of processing time to allocate to each of the multiple different application types. Performing the resource allocation process can include allocating no processing resources to one of the application types. In some implementations, performing the resource allocation process includes reducing processing resources for one of the applications over one or more operational cycles.

In some implementations, the control subsystem of the multi-purpose radar system is configured to determine a malfunction of the multi-purpose radar system and in response to determining the malfunction, reconfigure antenna weights. In some implementations, the control subsystem is configured to select a different processing algorithm for a particular application type. In some implementations, selecting a different processing algorithm includes switching from a searching or tracking algorithm to an algorithm for communicating data wirelessly.

In some implementations, the control subsystem is configured to detect electromagnetic interference in a receive signal of the analog-to-digital subsystem and in response to detecting electromagnetic interference, select a different waveform for transmit by the one or more subarrays. The control subsystem can be configured to detect electromagnetic interference in a receive signal of the analog-to-digital subsystem and in response to detecting electromagnetic interference, select a different resource allocation for a subsystem of the multi-purpose radar system. The control subsystem can be configured to integrate results of one or more processing algorithms with processing results received from one or more other multi-purpose radar systems to ensure time and phase alignment coherency.

In some implementations, the process 500 includes determining, from an ordered list of applications, a sequence of waveforms corresponding to a plurality of beams. The ordered list of applications can include at least one of (i) different instances of an identical application (e.g., performing the same application multiple times), or (ii) an instance of different applications (e.g., performing different applications at the same time). The process can include generating the plurality of beams from the sequence of waveforms, for transmit by the antenna array of the radar system. The process 500 can include obtaining, through the antenna array of the radar system, received signals associated with the transmitted plurality of beams and processing, for each beam of the transmitted plurality of beams and according to the ordered list of applications, a subset of the received signals associated with the beam.

In some implementations, the process 500 includes identifying a subset of beams from the transmitted plurality of beams that share an identical application type and providing detections associated with the subset of the received signals that share the identical application type. The ordered list of radar applications is based on data received from one or more interfaces of the radar system, e.g., a weather interface 152, a defense interface 154. In some implementations, the process 500 includes steering the beams at one or more positions of an environment of the radar system based on the sequence of waveforms.

In some implementations, the multi-purpose radar system includes a digital-to-analog subsystem that is configured to generate arbitrary waveforms. The digital-to-analog subsystem is a modular subsystem that can be replaced by an alternative digital-to-analog subsystem.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a graphics processing unit (GPU), a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A multi-purpose radar system comprising:
one or more subarrays of electronically steered transmit/receive elements;
a digital signal processing subsystem comprising a plurality of digital processing elements and a memory subsystem comprising one or more memories;
an analog-to-digital subsystem configured to receive the analog output of the one or more subarrays and to store a digital representation of the analog output into the memory subsystem; and
a control subsystem configured to direct the digital signal processing subsystem to perform a plurality of different processing algorithms on the data stored in the memory subsystem.

2. The multi-purpose radar system of claim 1, wherein the multi-purpose radar system is configured to simultaneously perform multiple different applications having different respective processing algorithms, each of the multiple different applications correspond to a different type of application.

3. The multi-purpose radar system of claim 2, wherein simultaneously performing multiple different applications comprises directing the digital signal processing subsystem to perform multiple different processing algorithms on the same set of data stored in the memory subsystem.

4. The multi-purpose radar system of claim 2, wherein simultaneously performing multiple different applications comprises directing the digital signal processing subsystem to perform multiple different processing algorithms over consecutive operational cycles of the radar.

5. The multi-purpose radar system of claim 2, wherein simultaneously performing multiple different applications comprises cycling between two or more processing algorithms over consecutive operational cycles of the radar.

6. The multi-purpose radar system of claim 1, wherein the control subsystem is configured to dynamically select a next processing algorithm for a next application on each operational cycle.

7. The multi-purpose radar system of claim 1, wherein the control subsystem is configured to select a next processing algorithm while digital signal processing subsystem is processing data for a current processing algorithm.

8. The multi-purpose radar system of claim 1, wherein the control system is configured to perform a real-time resource allocation process to determine which resources to allocate to each of the multiple different application types.

9. The multi-purpose radar system of claim 8, wherein performing the resource allocation process comprises determining an amount of processing time to allocate to each of the multiple different application types.

10. The multi-purpose radar system of claim 8, wherein performing the resource allocation process comprises allocating no processing resources to one of the application types.

11. The multi-purpose radar system of claim 8, wherein performing the resource allocation process comprises reducing processing resources for one of the applications over one or more operational cycles.

12. The multi-purpose radar system of claim 1, wherein the plurality of digital processing elements are graphics processing units and the memory subsystem is one or more integrated memories of the graphics processing units.

13. The multi-purpose radar system of claim 1, wherein the memory subsystem is configured to store an entire range window of data over a wide portion of RF spectrum.

14. The multi-purpose radar system of claim 13, wherein the range window stored by the memory subsystem is over 100 km of range and can be processed at full bandwidth of the multi-purpose radar system.

15. The multi-purpose radar system of claim 1, further comprising a digital-to-analog subsystem that is configured to generate arbitrary waveforms.

16. The multi-purpose radar system of claim 1, wherein the digital-to-analog subsystem is a modular subsystem that can be replaced by an alternative digital-to-analog subsystem.

17. The multi-purpose radar system of claim 1, wherein the one or more subarrays of electronically steered transmit/receive elements are configured to capture a wide portion of the RF spectrum.

18. The multi-purpose radar system of claim 1, wherein the control subsystem is configured to:
determine a malfunction of the multi-purpose radar system; and
in response to determining the malfunction, reconfigure antenna weights.

19. The multi-purpose radar system of claim 1, wherein the control subsystem is configured to select a different processing algorithm for a particular application type.

20. The multi-purpose radar system of claim 19, wherein the control subsystem is configured to:
detect electromagnetic interference in a receive signal of the analog-to-digital subsystem; and
in response to detecting electromagnetic interference, select a different waveform for transmit by the one or more subarrays.

21. The multi-purpose radar system of claim 19, wherein the control subsystem is configured to:
detect electromagnetic interference in a receive signal of the analog-to-digital subsystem; and
in response to detecting electromagnetic interference, select a different resource allocation for a subsystem of the multi-purpose radar system.

22. The multi-purpose radar system of claim 19, wherein selecting a different processing algorithm comprises switching from a searching or tracking algorithm to an algorithm for communicating data wirelessly.

23. The multi-purpose radar system of claim 1, wherein the multi-purpose radar system is configured to simultaneously perform two or more of the following applications: aircraft detection, aircraft tracking, communications, weather monitoring, or interceptor guidance.

24. The multi-purpose radar system of claim 23, wherein the control subsystem is configured to integrate results of one or more processing algorithms with processing results received from one or more other multi-purpose radar systems to ensure time and phase alignment coherency.

25. The multi-purpose radar system of claim 1, wherein the multi-purpose radar system is configured to perform at least one type of application simultaneously.

26. A method performed by a radar system in an environment, the method comprising:
obtaining, by an antenna array of the radar system, radio frequency detections from one or more objects in the environment;
identifying, by a digital signal processing subsystem of the radar system, a first subset of the radio frequency (RF) detections for processing during a first period of time;
processing, during the first period of time and by the digital signal processing subsystem of the radar system, the first subset of radio frequency detections to identify objects from the one or more objects in the environment associated with a first application of the radar system;
while processing the first subset of radio frequency detections for the first application of the radar system during the first period of time, identifying a second subset of the radio frequency detections for processing during a second period of time, wherein the second subset of radio frequency detections are associated with a second application of the radar system;
processing, during the second period of time and by the digital signal processing subsystem of the radar system, the second subset of radio frequency detections to identify objects from the one or more objects in the environment associated with the second application of the radar system; and
generating radar data related to one or more identified objects from the one or more objects based on processing the first subset of radio frequency detections and the second subset of radio frequency detections.

27. The method of claim 26, further comprising:
determining, from an ordered list of applications, a sequence of waveforms corresponding to a plurality of beams, wherein the ordered list of applications comprises at least one of (i) different instances of an identical application, or (ii) an instance of different applications;
generating, from the sequence of waveforms, the plurality of beams for transmit by the antenna array of the radar system;
obtaining, through the antenna array of the radar system, received signals associated with the transmitted plurality of beams; and
processing, for each beam of the transmitted plurality of beams and according to the ordered list of applications, a subset of the received signals associated with the beam.

28. The method of claim 26, further comprising:
identifying a subset of beams from the transmitted plurality of beams that share an identical application type; and
providing detections associated with the subset of the received signals that share the identical application type.

29. The method of claim 27, wherein the ordered list of radar applications is based on data received from one or more interfaces of the radar system.

30. The method of claim 27, wherein generating the plurality of beams for transmit comprises steering the beams at one or more positions of an environment of the radar system based on the sequence of waveforms.

31. One or more computer storage media encoded with instructions that are operable, when executed by data processing apparatus, to cause the data processing apparatus to perform operations comprising:
obtaining, by an antenna array of the radar system, radio frequency detections from one or more objects in the environment;
identifying, by a digital signal processing subsystem of the radar system, a first subset of the radio frequency detections for processing during a first period of time;
processing, during the first period of time and by the digital signal processing subsystem of the radar system, the first subset of radio frequency detections to identify objects from the one or more objects in the environment associated with a first application of the radar system;
while processing the first subset of radio frequency detections for the first application of the radar system during the first period of time, identifying a second subset of the radio frequency detections for processing during a second period of time, wherein the second subset of radio frequency detections are associated with a second application of the radar system;
processing, during the second period of time and by the digital signal processing subsystem of the radar system, the second subset of radio frequency detections to identify objects from the one or more objects in the environment associated with the second application of the radar system; and
generating radar data related to one or more identified objects from the one or more objects based on processing the first subset of radio frequency detections and the second subset of radio frequency detections.
